(19) United States
(12) Patent Application Publication
(10) Pub. No.: US 2023/0297557 A1
(43) Pub. Date: Sep. 21, 2023

(54) METHOD FOR MONITORING A STATE OF AN EXTERNAL DATA SOURCE, DEVICE, AND MEDIUM

(71) Applicant: Beijing Baidu Netcom Science Technology Co., Ltd., Beijing (CN)

(72) Inventor: Xiaohe LIU, Beijing (CN)

(21) Appl. No.: 18/184,472

(22) Filed: Mar. 15, 2023

(30) Foreign Application Priority Data
Mar. 15, 2022 (CN) 202210251192.8

(51) Int. Cl. G06F 16/23; G06F 21/64

(52) U.S. Cl. CPC G06F 16/2358; G06F 21/64; G06F 16/2379

(57) ABSTRACT

Provided are a method and apparatus for monitoring a state of an external data source, a device, and a medium, relating to the field of computer technology and, in particular, to blockchain technology. The method is applied by a blockchain node and includes acquiring a data subscription transaction request initiated by a client; invoking an oracle contract to perform the data subscription transaction request to record a target data subject subscribed by a user and control an oracle node to monitor a change of target data of the target data subject provided by the external data source; acquiring a change event of the target data subject fed back by the oracle node and uploading the change event to a chain to enable the client to monitor the change event. The preceding technical solution implements the monitoring of the state change of the external data source.

### CROSS-REFERENCE TO RELATED APPLICATION(S)

This application claims the priority to Chinese Patent Application No. CN202210251192.8 and filed on Mar. 15, 2022, the disclosure of which is incorporated herein by reference in its entirety.

### TECHNICAL FIELD

The present disclosure relates to the field of computer technology and, in particular, to blockchain technology.

### BACKGROUND

Since a blockchain system is a deterministic environment, if an external data source is to be accessed, the access may be implemented through an oracle mechanism.

The service contract in a blockchain may access the external data source through an oracle service. However, there may be multiple external data sources, and data content may be constantly changing. Furthermore, it is difficult for the service contract and the user on the blockchain to be informed of the data change in the external data source in time.

### SUMMARY

The present disclosure provides a method and apparatus for monitoring a state of an external data source, a device, and a medium to implement the monitoring of the state change of the external data source.

According to an aspect of the present disclosure, a method and apparatus for monitoring a state of an external data source, a device, and a medium are provided and applied by a blockchain node. The method includes the steps below.

A data subscription transaction request initiated by a client is acquired.

An oracle contract is invoked to perform the data subscription transaction request to record a target data subject subscribed by a user and control an oracle node to monitor a change of target data of the target data subject provided by the external data source.

A change event of the target data subject fed back by the oracle node is acquired. The change event is uploaded to a chain to enable the client to monitor the change event.

According to another aspect of the present disclosure, a method and apparatus for monitoring a state of an external data source, a device, and a medium are provided and applied by the oracle node. The method includes the steps below.

The data subscription transaction request performed by the oracle contract deployed on a blockchain is acquired. The data subscription transaction request is initiated by the client.

A target data subject subscribed by a user is determined according to the data subscription transaction request. The change of target data of the target data subject provided by the external data source is monitored to obtain a change event of the target data subject.

The change event of the target data subject is fed back to the oracle contract to enable the oracle contract to upload the change event to the chain to enable the client to monitor the change event.

According to another aspect of the present disclosure, an electronic device is provided.

The electronic device includes at least one processor and a memory communicatively connected to the at least one processor.

The memory stores instructions executable by the at least one processor to enable the at least one processor to perform any method for monitoring a state of an external data source according to embodiments of the present disclosure.

According to another aspect of the present disclosure, a non-transitory computer-readable storage medium is provided. The storage medium stores computer instructions for causing a computer to perform any method for monitoring a state of an external data source according to the embodiments of the present disclosure.

According to the technology of the present disclosure, valid monitoring of the state change in the external data source is implemented.

It is to be understood that the content described in this part is neither intended to identify key or important features of the embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure.

FIG. 1 is a flowchart of a method for monitoring a state of an external data source according to an embodiment of the present disclosure.

FIG. 2 is a flowchart of another method for monitoring a state of an external data source according to an embodiment of the present disclosure.

FIG. 3A is a flowchart of another method for monitoring a state of an external data source according to an embodiment of the present disclosure.

FIG. 3B is an interaction diagram of a method for monitoring a state of an external data source according to an embodiment of the present disclosure.

FIG. 4 is a diagram illustrating the structure of an apparatus for monitoring a state of an external data source according to an embodiment of the present disclosure.

FIG. 5 is a diagram illustrating the structure of an apparatus for monitoring a state of an external data source according to an embodiment of the present disclosure.

FIG. 6 is a block diagram of an electronic device for performing a method for monitoring a state of an external data source according to an embodiment of the present disclosure.

### DETAILED DESCRIPTION

Example embodiments of the present disclosure, including details of embodiments of the present disclosure, are described hereinafter in conjunction with drawings to facilitate understanding. The example embodiments are illustrative only. Therefore, it is to be appreciated by those of ordinary skill in the art that various changes and modifications may be made to the embodiments described herein without departing from the scope and spirit of the present disclosure. Similarly, description of well-known functions and constructions is omitted hereinafter for clarity and conciseness.

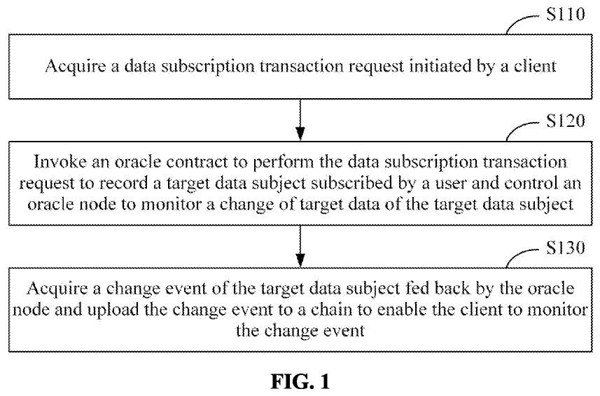

FIG. 1 is a flowchart of a method for monitoring a state of an external data source according to an embodiment of the present disclosure. This embodiment of the present disclosure is applied to the service contract and the user on a blockchain and can be informed of the data change in the external data source in time. The method may be performed by an apparatus for monitoring a state of an external data source. This apparatus may be performed by hardware and/or software and may be configured in an electronic device. The electronic device may be a blockchain node. With reference to FIG. 1, the method is applied by the blockchain node and includes the steps below.

In S110, a data subscription transaction request initiated by a client is acquired.

The client of the blockchain may be configured by the user to initiate a request to invoke a smart contract to the blockchain according to the actual requirement of the user and may also be configured to monitor the event on the blockchain.

The data subscription transaction request may be a subscription transaction request initiated by the user to the blockchain node through the client of the blockchain according to the requirement of the user.

For example, the user may acquire the interface provided by an oracle contract through the client of the blockchain, subscribe to data that can satisfy the requirement or interest of the user, and initiate a data subscription request to the blockchain node. The request is the data subscription transaction request. The blockchain node acquires the data subscription transaction request initiated by the client.

Since the blockchain is a deterministic environment and does not allow for indeterminate things or factors, the smart contract must be a consistent result whenever and wherever the smart contract operates. As a result, when the blockchain initiates external data, and when different blockchain nodes access different external data sources, there may be inconsistent access results. Furthermore, since the data in an external data source may also change dynamically, indeterminate factors are also introduced. The inconsistent off-chain data access results obtained above may lead to indeterminacy in the operation result on the blockchain. For this reason, as the interface between the blockchain and the external environment, an oracle can transfer the external data to the blockchain and implement the data interaction between the blockchain and the external environment. Moreover, the blockchain can trust the external data acquired by the oracle. The oracle contract deployed in the blockchain is configured to process a transaction request on the chain. The oracle node deployed off the blockchain is configured to acquire off-chain data and feed the data acquired off the chain back to the oracle contract on the chain.

In S120, the oracle contract is invoked to perform the data subscription transaction request to record a target data subject subscribed by a user and control the oracle node to monitor a change of target data of the target data subject.

The oracle contract may be the smart contract configured to process the subscription data transaction request, that is, after the user initiates the data subscription transaction request, the blockchain invokes the oracle contract to perform the data subscription transaction request initiated by the user.

The target data subject may be a data subject subscribed by the user. One or more target data subjects may be configured. The target data subject may be determined by processing the data subscription transaction request. Target data corresponding to the target data subject (which is also described as the target data of the target data subject or the target data associated with the target data subject) is the data provided by the external data source which is also required or interested by the user who subscribes to the target data subject. The target data may be the data provided by a set external data source or a set of certain types of data. The target data may be determined and provided by the external data source or by the oracle contract.

The oracle contract may manage at least one data subject to which the user can subscribe and publish the data subject to the blockchain so that the user may subscribe to, through the client of the blockchain, the at least one data subject according to the requirement of the user. The oracle node can monitor the change of the data associated with the target data subject, that is, the oracle node can monitor the external data source in real time. If the data of the external data source changes, the oracle node can feed the changed data associated with the target data subject back to the blockchain node. One or more oracle nodes may be configured.

For example, after the blockchain node acquires the data subscription transaction request initiated by the client, the oracle contract is invoked to perform the data subscription transaction request. The oracle contract determines the target data subject according to the data subscription transaction request and records the subscribed target data subject. The oracle contract controls the oracle node to monitor the target data associated with the target data subject in the external data source.

It is to be noted that the oracle contract on the blockchain node may control the oracle node in a manner of interface invocation. However, there may be multiple blockchain nodes and multiple oracle nodes. To avoid the generation of a large number of data sending requests or data invocation requests, the oracle contract on the blockchain node may control the oracle node in a manner of the generation of an event log.

In an optional embodiment, the oracle contract is invoked to perform the data subscription transaction request to record the subscribed target data subject and control the oracle node to monitor the data change of the target data subject in the following manners: The oracle contract is invoked to perform the data subscription transaction request, and the event log is generated. The event log is configured to, in response to being monitored by the oracle node, trigger the oracle node to acquire the target data subject in the event log and monitor the change of the target data of the target data subject.

The to-be-recorded content in the event log may be preset by the related technical personnel when the related technical personnel deploy the oracle contract. For example, the event log may be event information generated during the performing of the data subscription transaction request by the oracle contract.

The event log may be recorded in the block header or the block body of the blockchain. A block includes a block header and a block body. The detailed data of the block may be recorded in the block body. For example, at least one piece of transaction request data generated or received during the performing of the blockchain may be recorded. The hash value of the previous block, the hash value of the current block, and at least one tree configured to record information may be recorded in the block header. For example, the event log may be recorded in a log tree in the block header. The log tree may be a data structure configured to record information of each event in the block. The event information may be related information of a data subscription event. For example, the event information may include the subject name of the subscribed target data subject.

For example, the blockchain node invokes the oracle contract to perform the data subscription transaction request. When the oracle contract performs the data subscription transaction request, the oracle contract may generate a corresponding data subscription event log during the processing of the data transaction subscription request and record the log in the block header or the block body to record the subscribed target data subject. The content formed in the event log may be predefined, that is, what information is set to be included in the data subscription event generated when the oracle contract performs the data subscription transaction request. For example, a data subject may be included. Accordingly, the event log may be broadcast in a network. The oracle node may monitor the event generated in the blockchain. If the data subscription event log is monitored, the oracle node may be triggered to acquire the target data subject in the event log, and the change of the target data associated with the target data subject is monitored.

In the solution of this optional embodiment, the oracle contract is invoked to perform the data subscription transaction request, and the event log is generated and recorded in the block header or the block body to record the subscribed target data subject. In this manner, the recording of the event log in the blockchain node is implemented. The oracle node may monitor the event log generated in the block to accurately acquire the target data subject in the blockchain node, thereby implementing timely acquisition of the target data subject on the chain. Additionally, in a monitoring manner, the oracle contract of the blockchain does not need to perform interface invocation on a specific blockchain node. A blockchain network includes multiple blockchain nodes. If the oracle nodes are separately invoked, a large number of data sending requests or data invocation requests may be generated.

In S130, a change event of the target data subject fed back by the oracle node is acquired. The change event is uploaded to the chain to enable the client to monitor the change event.

The change event of the target data subject may be an event in the external data source where the target data associated with the target data subject changes.

For example, the oracle node may monitor the external data source in real time and feed the change event back to the blockchain node when the oracle node finds through monitoring that the target data associated with the target data subject in the external data source changes. The blockchain node acquires the change event of the target data subject fed back by the oracle node and uploads the change event to the chain. The oracle contract updates the target data subject associated with the change event according to the change event, so that the client who subscribes to the target data subject can monitor the change event. The change event may reflect the state of the change of the target data, or may reflect that which data changes in a fine-grained manner, and may reflect specific data change content.

It is to be noted that when the user monitors the change of the target data subject through the client, the service contract deployed by the user may automatically acquire the changed data. Specifically, when the client monitors the data change, the service contract is automatically triggered to acquire new data. Optionally, the user may manually determine whether there is a requirement to acquire new data. If so, a service transaction request may be initiated, and the service contract acquires the changed data.

In an optional embodiment, in the process of performing the service transaction request initiated by the service contract, in response to monitoring a request to acquire the target data provided by the external data source, the oracle contract is invoked to control the oracle node to read the target data from the external data source and feed the target data back to the oracle contract.

The service contract may be a smart contract deployed in a blockchain system and configured to implement various service functions. The service transaction request may be a transaction request initiated by the user to the service contract through the client of the blockchain according to the requirement of the user. The target data may be data associated with the target data subject subscribed by the user.

For example, after the client monitors the change event, it may be determined whether it is necessary to acquire the changed new data according to the requirement of the user. If so, the user may initiate the service transaction request through the service contract. In the process where the blockchain node performs the service transaction request initiated by the service contract, if it is monitored that the request is a request to acquire the target data provided by the external data source, the oracle contract is invoked. The oracle contract controls the oracle node to read the target data from the external data source and feeds the target data back to the oracle contract. The service contract may acquire the target data through cross-contract invocation.

In this optional embodiment, in the process of performing the service transaction request initiated by the service contract, it is determined whether the acquisition requirement of the target data provided by the external data source is monitored. If so, the oracle contract is invoked to control the oracle node to read the target data from the external data source and feeds the target data back to the oracle contract. In this manner, the user can determine whether to acquire the changed data according to the requirement of the user, thereby improving the convenience of the user in acquiring the target data.

In this embodiment of the present disclosure, the data subscription transaction request initiated by the client is acquired. The oracle contract is invoked to perform the data subscription transaction request to record the subscribed target data subject and control the oracle node to monitor the change of the target data of the target data subject. The change event of the target data subject fed back by the oracle node is acquired. The change event is uploaded to the chain to enable the client to monitor the change event. In the preceding solutions, the user subscribes the data change event to the oracle contract through the client to control the oracle node to monitor the change of the target data of the external data source. Through the publishing of the change event by the oracle contract, the user can be informed of the change of the subscribed data in time, so that when the data source is updated, the user acquires the changed data in time. In this manner, the convenience of the user is improved. Additionally, through the publishing of a subscription, the oracle node does not need to respond to multiple requests and send multiple times of data, thereby reducing the consumption of a blockchain computation resource and a blockchain storage resource.

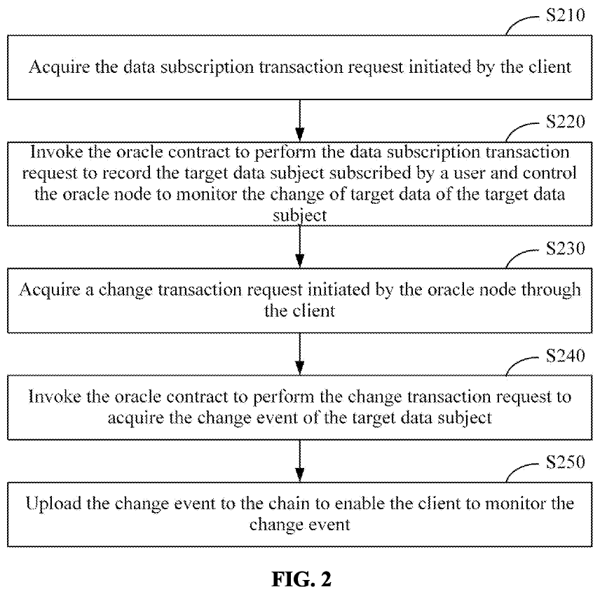

FIG. 2 is a flowchart of another method for monitoring a state of an external data source according to an embodiment of the present disclosure. This embodiment is an optional solution provided based on the preceding embodiments.

With reference to FIG. 2, the method provided by this embodiment includes the steps below.

In S210, the data subscription transaction request initiated by the client is acquired.

In S220, the oracle contract is invoked to perform the data subscription transaction request to record the subscribed target data subject and control the oracle node to monitor the change of the target data of the target data subject.

In S230, a change transaction request initiated by the oracle node through the client is acquired.

The change transaction request may be a request sent by the oracle node to the blockchain when the data associated with the target data subject in the external data source changes. The change transaction request is configured to represent the change event of the target data subject.

For example, when the oracle node finds through monitoring that the target data associated with the target data subject in the external data source changes, the oracle node may initiate the change transaction request to the blockchain through the client of the blockchain.

In S240, the oracle contract is invoked to perform the change transaction request to acquire the change event of the target data subject.

For example, when the blockchain node acquires the change transaction request initiated by the oracle node, the oracle contract is invoked to perform the change transaction request. The oracle node acquires the change event of the target data subject and updates the event content of the change event. For example, the subject name of the target data subject corresponding to the change event may be updated.

Optionally, the oracle node may be pre-registered in the blockchain node. Specifically, the oracle node may send a registration transaction request to the blockchain node. In the process of the performing of the registration transaction request by the oracle node, the oracle contract is invoked, and the identifier and the public key of the oracle node in the registration transaction request are acquired and stored on the chain. The registration transaction request may be a transaction request for information registration initiated by the oracle node to the blockchain node. The identifier of the oracle node may be a unique identifier that represents the oracle node. The public key of the oracle node may be configured to verify the change transaction request fed back by the oracle node.

In an optional embodiment, invoking the oracle contract to perform the change transaction request also includes the following: based on the public key of the oracle node registered in the oracle contract, validity verification is performed on an signature of the oracle node signature in the change transaction request and matching verification is performed on an account of the oracle node signature in the change transaction request.

The oracle node signature may be a signature of the oracle node for the request parameter of the change transaction request with the use of a private key. The request parameter may include a subject name, target data, or a timestamp of the target data subject.

For example, the blockchain node may verify whether the oracle node signature is valid and whether the account of the oracle node matches based on the public key of the oracle node registered in the oracle contract. It is verified whether the account of oracle nodes matches, specifically, that is, it is verified whether the address of the oracle node is a valid oracle node address. The oracle node address may be generated by the public key of the oracle node.

In this optional embodiment, based on the public key of the oracle node registered in the oracle contract, validity verification is performed on an signature of the oracle node signature in the change transaction request and matching verification is performed on an account of the oracle node signature in the change transaction request. In this manner, verification is performed on the oracle node and the change transaction request sent by the oracle node, thereby ensuring the validity and reliability of the oracle node and the data sent by the oracle node.

It is to be noted that in the process of invoking the oracle contract to perform the change transaction request, it is possible to determine whether the target data of the target data subject changes based on the timestamp in the request parameter of the change transaction request and the latest timestamp recorded on the blockchain.

In an optional embodiment, invoking the oracle contract to perform the change transaction request also includes the following: A change timestamp of the target data subject is acquired from the change transaction request, and the change timestamp is compared with the latest timestamp of the target data subject recorded on the chain; and in response to the latest timestamp being earlier than the change timestamp, it is determined that the data of the target data subject changes.

The change time stamp may be a timestamp of the target data subject acquired by the blockchain node from the current change transaction request. The latest timestamp may be a timestamp of the target data subject acquired by the last change transaction request recorded on the blockchain.

For example, the blockchain node acquires the change timestamp of the target data subject from the change transaction request sent by the oracle node and acquires the latest timestamp of the target data subject recorded on the chain. The change timestamp is compared with the latest timestamp. It is determined whether the latest timestamp is earlier than the change timestamp. If so, it is determined that the data of the target data subject changes. If not, it is determined that the data of the target data subject does not change.

In this optional embodiment, the change timestamp of the target data subject is acquired and compared with the latest timestamp. It is determined that the target data of the target data subject changes. In this manner, accurate determination of whether the target data of the target data subject changes is implemented, thereby improving the accuracy of the acquisition of the change event of the target data subject.

In S250, the change event is uploaded to the chain to enable the client to monitor the change event.

In the solution of this embodiment of the present disclosure, the change transaction request initiated by the oracle node through the client is acquired. The oracle contract is invoked to perform the change transaction request to acquire the change event of the target data subject. In the preceding solutions, the oracle contract is invoked to perform the change transaction request, so that the change event of the target data subject is acquired in time, thereby facilitating the subsequent monitoring of the change event by the client. The change transaction request sent by the oracle node is acquired, so that the changed external data associated with the target data subject in the external data source is acquired in time, and the user acquires the subscribed target data in time. In this manner, the convenience of the user is improved.

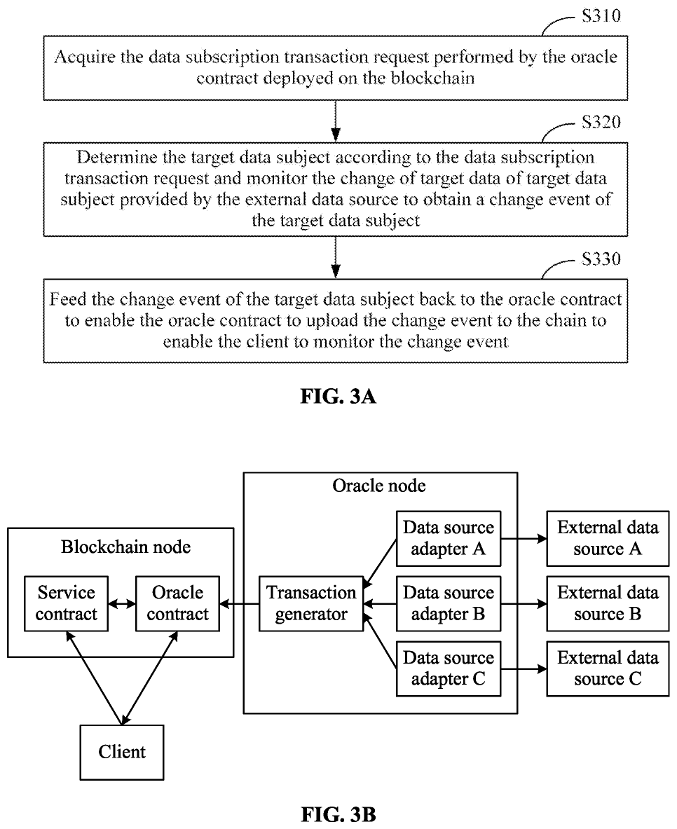

FIG. 3A is a flowchart of a method for monitoring a state of an external data source according to an embodiment of the present disclosure. This embodiment of the present disclosure may be applied to the service contract and the user on the blockchain and can be informed of the data change in the external data source in time. The method may be performed by an apparatus for monitoring a state of an external data source. This apparatus may be performed by hardware and/or software and may be configured in an electronic device. The electronic device may be the oracle node. With reference to FIG. 3A, the method is applied by the oracle node and includes the steps below.

In S310, the data subscription transaction request performed by the oracle contract deployed on the blockchain is acquired.

The data subscription transaction request may be initiated by the client. The oracle contract may be the smart contract configured to process the subscription data transaction request. The data subscription transaction request may be a subscription transaction request initiated by the user to the blockchain node through the client of the blockchain according to the requirement of the user.

In an optional embodiment, the data subscription transaction request performed by the oracle contract deployed on the blockchain is acquired in the following manners: The event log in the blockchain is monitored, and the event log may be recorded in the block header or the block body; and in response to monitoring the data subscription transaction request in the event log, the data subscription transaction request is read from the event log.

The event log may be event information generated during the performing of the data subscription transaction request by the oracle contract.

For example, the oracle node may monitor the event log in the blockchain. When the event log of the data subscription transaction request is monitored, the data subscription transaction request may be acquired from the event log. In this manner, the timely acquisition of the data subscription transaction request in the blockchain is implemented.

In this optional embodiment, the event log in the blockchain is monitored. In this manner, the acquisition of the data subscription transaction request is implemented. In response to monitoring the data subscription transaction request in the event log, the data subscription transaction request is read from the event log. The event log in the blockchain is monitored, so that the oracle node does not need to interface with the oracle contract. The blockchain network includes multiple blockchain nodes. If the oracle node interfaces with a large number of blockchain nodes separately, the oracle node may acquire a large number of invocation requests sent by interfaces.

In S320, the subscribed target data subject is determined according to the data subscription transaction request. The change of the target data of the target data subject provided by the external data source is monitored.

The target data subject may be the data subject subscribed by the user. One or more target data subjects may be configured. The target data may be data corresponding to the target data subject, that is, data provided by the external data source, or the data required or interested by the user who subscribes to the target data subject.

For example, the oracle node reads the data subscription transaction request from the monitored event log and determines the subscribed target data subject according to the data subscription transaction request. The oracle node monitors the change of the target data associated with the target data subject provided by the external data source in a regular or real-time manner.

In an optional embodiment, the change of the target data of the target data subject provided by the external data source is monitored in the following manners: The change of the target data of the target data subject in the external data source is polled and monitored through a data source adapter in the oracle node; and in response to being monitored, the target data of the target data subject is acquired and compared with locally stored data to verify the data change.

The data source adapter may be adapted to the invocation interface of the external data source to acquire the data provided by the external data source.

For example, at least one data source adapter may be deployed in the oracle node and adapted to an application programming interface (API) corresponding to the external data source. The number of external data sources may correspond to the number of data source adapters, that is, one data source adapter may be adapted to an API corresponding to one external data source. The change of the target data corresponding to the target data subject in the external data source is polled and monitored through the data source adapter in the oracle node, and it is determined whether the data changes. If the change of the target data corresponding to the target data subject is monitored, the target data of the target data subject is acquired. The data source adapter compares the acquired target data with the locally stored data and determines whether the comparison result is consistent. If so, it is determined that the target data changes. If not, it is determined that the target data does not change. If the target data changes, the data source adapter updates the locally stored data according to the changed target data.

In this optional embodiment, the change of the target data of the target data subject in the external data source is polled and monitored through the data source adapter in the oracle node, so that the changed data corresponding to the target data subject in the external data source is monitored. In response to being monitored, the target data of the target data subject is acquired and compared with the locally stored data to verify the data change. In this manner, the target data acquired from the external data source is verified, and it is possible to accurately determine whether the data is updated or not.

In S330, the monitored change event of the target data subject is fed back to the oracle contract to enable the oracle contract to upload the change event to the chain to enable the client to monitor the change event.

The change event of the target data subject may be the event in the external data source where the data associated with the target data subject changes.

For example, the oracle node can feed the monitored change event of the target data subject back to the blockchain node. The blockchain node invokes the oracle contract to upload the change event to the chain to enable the client to monitor the change event.

In an optional embodiment, the monitored change event of the target data subject is fed back to the oracle contract in the following manner: The change transaction request is initiated by the client to represent the monitored change event of the target data subject. The change transaction request is performed by the oracle contract.

The change transaction request may be the request sent by the oracle node to the blockchain when the data associated with the target data subject in the external data source changes. The change transaction request is configured to represent the change event of the target data subject.

For example, when the oracle node finds through monitoring that the target data associated with the target data subject in the external data source changes, the oracle node may initiate the change transaction request to the blockchain through the client of the blockchain.

In this optional embodiment, the change transaction request is initiated by the client to represent the monitored change event of the target data subject, so that the change event of the target data subject is acquired by the blockchain node, thereby facilitating the subsequent monitoring of the change event by the client.

In a specific embodiment, reference is made to an interaction diagram of a method for monitoring a state of an external data source shown in FIG. 3B. The user may initiate the data subscription transaction request to the blockchain node through the client of the blockchain. The blockchain node invokes the oracle contract to perform the data subscription transaction request. The event log is generated and recorded in the block header or the block body to record the subscribed target data subject. The oracle node may monitor the event log. The oracle node includes a transaction generator, a data source adapter A, a data source adapter B, and a data source adapter C. The data source adapter A is adapted to the API of an external data source A. The data source adapter B is adapted to the API of an external data source B. The data source adapter C is adapted to the API of an external data source C. When the oracle node monitors the data subscription transaction request in the event log, the data subscription transaction request is read from the event log. The oracle node determines the subscribed target data subject according to the data subscription transaction request and monitors the change of the target data of the target data subject in the external data source through the data source adapter. When the data source adapter monitors a change of the target data associated with the target data subject in the external data source, the target data of the target data subject is compared with the locally stored data to verify the data change. If the target data changes, the target data and the subject name and timestamp of the target data subject are sent to the transaction generator. The transaction generator uses the target data and the subject name and timestamp of the target data subject as request parameters of the change transaction request and signs them with a private key. The transaction generator sends the signed change transaction request to the blockchain node. The blockchain node verifies the oracle node signature in the change transaction request based on the public key of the oracle node pre-registered in the oracle contract. Specifically, the blockchain node may verify the validity of the signature and verify whether the address is a valid oracle node address, and verify whether the timestamp is greater than the latest timestamp of the target data subject. If the verification is successful, the oracle contract updates the target data and the timestamp of the target data subject and uploads the change event to the chain. The client monitors the change event, in the process of performing the service transaction request initiated by the service contract, in response to monitoring a request to acquire the target data provided by the external data source, the oracle contract is invoked to control the oracle node to read the target data from the external data source and feed the target data back to the oracle contract.

In this embodiment of the present disclosure, the data subscription transaction request performed by the oracle contract deployed on the blockchain is acquired. The subscribed target data subject is determined according to the data subscription transaction request. The data change of target data provided by the external data source is monitored. The monitored change event of the target data subject is fed back to the oracle contract to enable the oracle contract to upload the change event to the chain to enable the client to monitor the change event. In the preceding solutions, the oracle node is deployed. The oracle node acquires and determines whether the target data associated with the target data subject changes. In this manner, the requirement of the user can be responded, and the changed data is acquired. Thus, when the data source is updated, the user acquires the changed data in time. Moreover, the convenience of the user is improved. Additionally, through the publishing of the subscription, the oracle node does not need to respond to multiple requests and send multiple times of data, thereby reducing the consumption of the blockchain computation resource and the blockchain storage resource.

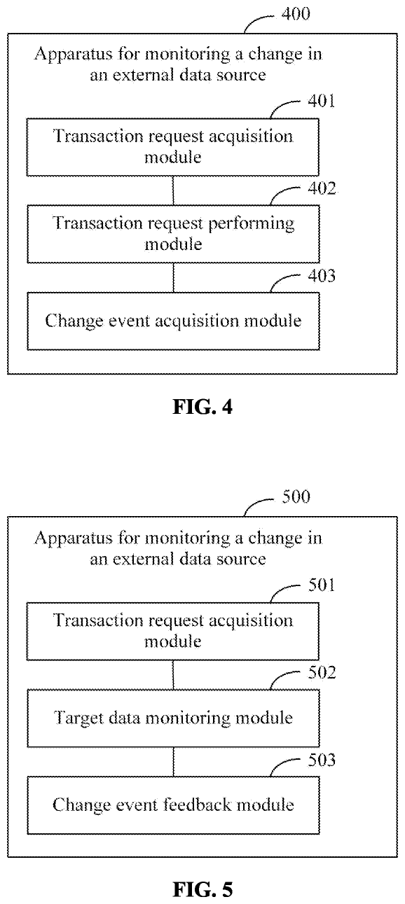

FIG. 4 is a diagram of an apparatus for monitoring a state of an external data source according to an embodiment of the present disclosure. This embodiment may be applied to the service contract and the user on the blockchain and can be informed of an application scenario of the change of the target data in the external data source in time. The apparatus is configured in an electronic device to implement the method described in any embodiment of the present disclosure. The electronic device may be the blockchain node. With reference to FIG. 4, the apparatus includes a transaction request acquisition module 401, a transaction request performing module 402, and a change event acquisition module 403.

The transaction request acquisition module 401 is configured to acquire the data subscription transaction request initiated by the client.

The transaction request performing module 402 is configured to invoke the oracle contract to perform the data subscription transaction request to record the subscribed target data subject and control the oracle node to monitor the change of the target data of the target data subject.

The change event acquisition module 403 is configured to acquire the change event of the target data subject fed back by the oracle node and upload the change event to the chain to enable the client to monitor the change event.

In this embodiment of the present disclosure, the user subscribes the data change event to the oracle contract through the client to control the oracle node to monitor the change of the target data of the external data source. Through the publishing of the change event by the oracle contract, the user can be informed of the change of the subscribed data in time, so that when the data source is updated, the user acquires the changed data in time. In this manner, the convenience of the user is improved. Additionally, through the publishing of the subscription, the oracle node does not need to respond to multiple requests and send multiple times of data, thereby reducing the consumption of the blockchain computation resource and the blockchain storage resource.

In an optional embodiment, the transaction request performing module 402 includes a transaction request invocation unit.

The transaction request invocation unit is configured to invoke the oracle contract to perform the data subscription transaction request and generate the event log which is recorded in the block header or the block body to record the subscribed target data subject.

The event log is configured to, in response to being monitored by the oracle node, trigger the oracle node to acquire the target data subject in the event log and monitor the change of the target data of the target data subject.

In an optional embodiment, the change event acquisition module 403 includes a change transaction request acquisition unit and a change transaction request invocation unit.

The change transaction request acquisition unit is configured to acquire the change transaction request initiated by the oracle node through the client. The change transaction request is configured to represent the change event of the target data subject.

The change transaction request invocation unit is configured to invoke the oracle contract to perform the change transaction request to acquire the change event of the target data subject.

In an optional embodiment, the change event acquisition module 403 also includes a signature verification unit.

The signature verification unit is configured to, based on the public key of the oracle node registered in the oracle contract, perform validity verification on an signature of the oracle node signature in the change transaction request and matching verification on an account of the oracle node signature in the change transaction request.

In an optional embodiment, the change event acquisition module 403 also includes a timestamp comparison unit and a change data determination unit.

The timestamp comparison unit is configured to acquire the change timestamp of the target data subject from the change transaction request and compare the change timestamp with the latest timestamp of the target data subject recorded on the chain.

The change data determination unit is configured to, in response to the latest timestamp being earlier than the change timestamp, determine that the target data of the target data subject changes.

In an optional embodiment, one or more oracle nodes are configured. One or more target data subjects are configured. The target data corresponding to the target data subject is the data provided by the external data source.

In an optional embodiment, the apparatus also includes an oracle contract invocation module.

The oracle contract invocation module is configured to, in the process of performing the service transaction request initiated by the service contract, in response to monitoring a request to acquire the target data provided by the external data source, invoke the oracle contract to control the oracle node to read the target data from the external data source and feed the target data back to the oracle contract.

The apparatus provided by the technical solutions of this embodiment of the present disclosure may perform the method provided by any embodiment of the present disclosure and has functional modules and beneficial effects corresponding to the method performed.

FIG. 5 is a diagram of an apparatus for monitoring a state of an external data source according to an embodiment of the present disclosure. This embodiment may be applied to the service contract and the user on the blockchain and can be informed of the application scenario of the change of the target data in the external data source in time. The apparatus is configured in an electronic device to implement the method described in any embodiment of the present disclosure. With reference to FIG. 5, the apparatus 500 includes a transaction request acquisition module 501, a target data monitoring module 502, and a change event feedback module 503.

The transaction request acquisition module 501 is configured to acquire the data subscription transaction request performed by the oracle contract deployed on the blockchain. The data subscription transaction request is initiated by the client.

The target data monitoring module 502 is configured to determine the subscribed target data subject according to the data subscription transaction request and monitor the change of the target data of target data provided by the external data source.

The change event feedback module 503 is configured to feed the monitored change event of the target data subject back to the oracle contract to enable the oracle contract to upload the change event to the chain to enable the client to monitor the change event.

In this embodiment of the present disclosure, the oracle node is deployed. The oracle node acquires and determines whether the target data associated with the target data subject changes. In this manner, the requirement of the user can be responded, and the changed data is required. Thus, when the data source is updated, the user acquires the changed data in time. Moreover, the convenience of the user is improved. Additionally, through the publishing of the subscription, the oracle node does not need to respond to multiple requests and send multiple times of data, thereby reducing the consumption of the blockchain computation resource and the blockchain storage resource.

In an optional embodiment, the transaction request acquisition module 501 includes an event log monitoring unit and a transaction request read unit.

The event log monitoring unit is configured to monitor the event log in the blockchain. The event log is recorded in the block header or the block body.

The transaction request read unit is configured to, in response to monitoring the data subscription transaction request in the event log, read the data subscription transaction request from the event log.

In an optional embodiment, the change event feedback module includes a change transaction request initiation unit.

The change transaction request initiation unit is configured to initiate the change transaction request through the client to represent the monitored change event of the target data subject. The change transaction request is performed by the oracle contract.

In an optional embodiment, the target data monitoring module 502 includes a data change monitoring unit and a target data acquisition unit.

The data change monitoring unit is configured to poll and monitor the change of the target data of the target data subject in the external data source through the data source adapter in the oracle node.

The target data acquisition unit is configured to, in response to monitoring the change of the target data, acquire the target data of the target data subject and compare the target data with the locally stored data to verify the data change.

The apparatus provided by the technical solutions of this embodiment of the present disclosure may perform the method provided by any embodiment of the present disclosure and has functional modules and beneficial effects corresponding to the method performed.

The acquisition of a transaction request or the invocation of the transaction request involved in the technical solutions of the present disclosure conforms to relevant laws and regulations and does not violate the public policy doctrine.

According to an embodiment of the present disclosure, the present disclosure also provides an electronic device, a readable storage medium, and a computer program product.

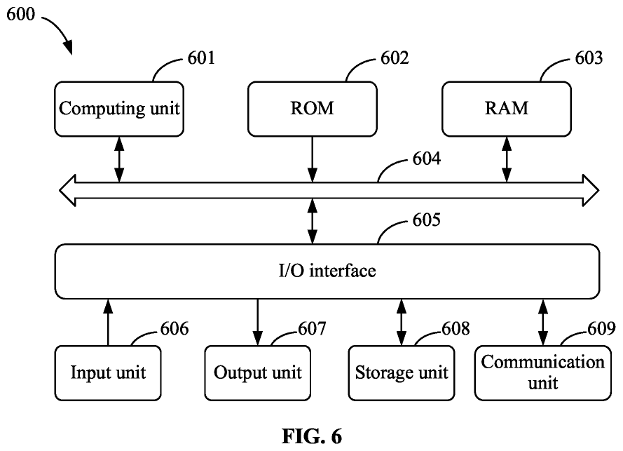

FIG. 6 is a block diagram of an example electronic device 600 that is configured to implement an embodiment of the present disclosure. The electronic device is intended to represent various forms of digital computers, for example, a laptop computer, a desktop computer, a workbench, a personal digital assistant, a server, a blade server, a mainframe computer, or another applicable computer. The electronic device may also represent various forms of mobile apparatuses, for example, a personal digital assistant, a cellphone, a smartphone, a wearable device, or a similar computing apparatus. Herein the shown components, the connections and relationships between these components, and the functions of these components are illustrative only and are not intended to limit the implementation of the present disclosure as described and/or claimed herein.

As shown in FIG. 6, the device 600 includes a computing unit 601. The computing unit 601 may perform various appropriate actions and processing according to a computer program stored in a read-only memory (ROM) 602 or a computer program loaded into a random-access memory (RAM) 603 from a storage unit 608. Various programs and data required for the operation of the device 600 may also be stored in the RAM 603. The computing unit 601, the ROM 602, and the RAM 603 are connected to each other through a bus 604. An input/output (I/O) interface 605 is also connected to the bus 604.

Multiple components in the device 600 are connected to the I/O interface 605. The multiple components include an input unit 606 such as a keyboard or a mouse, an output unit 607 such as various types of displays or speakers, the storage unit 608 such as a magnetic disk or an optical disc, and a communication unit 609 such as a network card, a modem or a wireless communication transceiver. The communication unit 609 allows the device 600 to exchange information/data with other devices over a computer network such as the Internet and/or various telecommunications networks.

The computing unit 601 may be various general-purpose and/or special-purpose processing components having processing and computing capabilities. Examples of the computing unit 601 include, but are not limited to, a central processing unit (CPU), a graphics processing unit (GPU), a special-purpose artificial intelligence (AI) computing chip, a computing unit performing machine learning models and algorithms, a digital signal processor (DSP), and any appropriate processor, controller and microcontroller. The computing unit 601 performs various preceding methods and processing, such as the method for monitoring a state of an external data source. For example, in some embodiments, the method may be implemented as a computer software program tangibly contained in a machine-readable medium such as the storage unit 608. In some embodiments, part or all of computer programs may be loaded and/or installed on the device 600 via the ROM 602 and/or the communication unit 609. When the computer program is loaded to the RAM 603 and performed by the computing unit 601, one or more steps of the preceding method may be performed. Alternatively, in other embodiments, the computing unit 601 may be configured, in any other appropriate manner (for example, by means of firmware), to perform the method.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting data and instructions to the memory system, the at least one input apparatus, and the at least one output apparatus.

Program codes for implementation of the methods of the present disclosure may be written in one programming language or any combination of multiple programming languages. The program codes may be provided for the processor or controller of a general-purpose computer, a special-purpose computer, or another programmable data processing apparatus to enable functions/operations specified in flowcharts and/or block diagrams to be implemented when the program codes are performed by the processor or controller. The program codes may be performed entirely on a machine, partly on a machine, as a stand-alone software package, partly on a machine and partly on a remote machine, or entirely on a remote machine or a server.

In the context of the present disclosure, the machine-readable medium may be a tangible medium that may include or store a program that is used by or used in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof More specific examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any suitable combination thereof.

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN), a blockchain network, and the Internet.

A computing system may include a client and a server. The client and the server are usually far away from each other and generally interact through the communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related virtual private server (VPS). The server may also be a server of a distributed system, or a server combined with a blockchain.

Artificial intelligence is the study of making computers simulate certain human thinking processes and intelligent behaviors (such as learning, reasoning, thinking and planning) both at the hardware and software levels. Artificial intelligence hardware technologies generally include technologies such as sensors, special-purpose artificial intelligence chips, cloud computing, distributed storage and big data processing. Artificial intelligence software technologies mainly include several major technologies such as computer vision technologies, speech recognition technologies, natural language processing technologies, machine learning/deep learning technologies, big data processing technologies and knowledge mapping technologies.

Cloud computing refers to a technical system that accesses a shared elastic-and-scalable physical or virtual resource pool through a network, where resources may include servers, operating systems, networks, software, applications and storage devices and may be deployed and managed in an on-demand, self-service manner. Cloud computing can provide efficient and powerful data processing capabilities for artificial intelligence, the blockchain and other technical applications and model training.

It is to be understood that various forms of the preceding flows may be used with steps reordered, added, or removed. For example, the steps described in the present disclosure may be performed in parallel, in sequence, or in a different order as long as the desired result of the technical solutions provided in the present disclosure is achieved. The performing sequence of these steps is not limited herein.

The scope of the present disclosure is not limited to the preceding embodiments. It is to be understood by those skilled in the art that various modifications, combinations, subcombinations, and substitutions may be made according to design requirements and other factors. Any modification, equivalent substitution, improvement and the like made within the spirit and principle of the present disclosure falls within the scope of the present disclosure.

What is claimed is:

1. A method for monitoring a state of an external data source, the method being applied by a blockchain node and comprising:
acquiring a data subscription transaction request initiated by a client;
invoking an oracle contract to perform the data subscription transaction request to record a target data subject subscribed by a user and controlling an oracle node to monitor a change of target data of the target data subject provided by the external data source; and
acquiring a change event of the target data subject fed back by the oracle node and uploading the change event to a chain to enable the client to monitor the change event.

2. The method according to claim 1, wherein invoking the oracle contract to perform the data subscription transaction request to record the subscribed target data subject and controlling the oracle node to monitor the change of the target data of the target data subject comprise:
invoking the oracle contract to perform the data subscription transaction request to generate an event log, wherein
the event log is configured to, in response to being monitored by the oracle node, trigger the oracle node to acquire the target data subject in the event log and monitor the change of the target data of the target data subject.

3. The method according to claim 1, wherein acquiring the change event of the target data subject fed back by the oracle node comprises:
acquiring a change transaction request initiated by the oracle node through the client, wherein the change transaction request is configured to represent the change event of the target data subject; and
invoking the oracle contract to perform the change transaction request to acquire the change event of the target data subject.

4. The method according to claim 3, wherein invoking the oracle contract to perform the change transaction request further comprises:
performing, based on a public key of the oracle node registered in the oracle contract, validity verification on a signature of the oracle node in the change transaction request and matching verification on an account of the oracle node in the change transaction request.

5. The method according to claim 3, wherein invoking the oracle contract to perform the change transaction request further comprises:
acquiring a change timestamp of the target data subject from the change transaction request and comparing the change timestamp with a latest timestamp of the target data subject recorded on the chain; and
in response to the latest timestamp being earlier than the change timestamp, determining that the data of the target data subject changes.

6. The method according to claim 1, wherein at least one oracle node is configured, at least one target data subject is configured.

7. The method of claim 1, further comprising:
in a process of performing a service transaction request initiated by a service contract, in response to monitoring a request to acquire the target data from the external data source, invoking the oracle contract to control the oracle node to read the target data from the external data source and feed the target data back to the oracle contract.

8. A method for monitoring a state of an external data source, the method being applied by an oracle node and comprising:
acquiring a data subscription transaction request performed by an oracle contract deployed on a blockchain, wherein the data subscription transaction request is initiated by a client;
determining, according to the data subscription transaction request, a target data subject subscribed by a user and monitoring a change of target data of the target data subject provided by the external data source to obtain a change event of the target data subject; and
feeding the change event of the target data subject back to the oracle contract to enable the oracle contract to upload the change event to the chain to enable the client to monitor the change event.

9. The method according to claim 8, wherein acquiring the data subscription transaction request performed by the oracle contract deployed on the blockchain comprises:
monitoring an event log in the blockchain; and
in response to monitoring the data subscription transaction request in the event log, reading the data subscription transaction request from the event log.

10. The method according to claim 8, wherein feeding the change event of the target data subject back to the oracle contract comprises:
initiating a change transaction request through the client to represent that the change event of the target data subject is monitored, wherein the change transaction request is performed by the oracle contract.

11. The method according to claim 8, wherein monitoring the change of the target data of the target data subject comprises:
polling and monitoring the change of the target data of the target data subject provided by the external data source through a data source adapter in the oracle node; and
in response to monitoring the change, acquiring the target data of the target data subject from the external data source and comparing the target data with locally stored data to verify the change.

12. An electronic device, comprising:
at least one processor; and
a memory communicatively connected to the at least one processor,
wherein the memory stores instructions executable by the at least one processor to enable the at least one processor to perform:
acquiring a data subscription transaction request initiated by a client;
invoking an oracle contract to perform the data subscription transaction request to record a target data subject subscribed by a user and controlling an oracle node to monitor a change of target data of the target data subject provided by the external data source; and
acquiring a change event of the target data subject fed back by the oracle node and uploading the change event to a chain to enable the client to monitor the change event.

13. The electronic device according to claim 12, wherein the at least one processor invokes the oracle contract to perform the data subscription transaction request to record the subscribed target data subject and controls the oracle node to monitor the change of the target data of the target data subject by:
invoking the oracle contract to perform the data subscription transaction request to generate an event log, wherein
the event log is configured to, in response to being monitored by the oracle node, trigger the oracle node to acquire the target data subject in the event log and monitor the change of the target data of the target data subject.

14. The electronic device according to claim 12, wherein the at least one processor acquires the change event of the target data subject fed back by the oracle node by:
acquiring a change transaction request initiated by the oracle node through the client, wherein the change transaction request is configured to represent the change event of the target data subject; and
invoking the oracle contract to perform the change transaction request to acquire the change event of the target data subject.

15. The electronic device according to claim 14, wherein the at least one processor invokes the oracle contract to perform the change transaction request by:
performing, based on a public key of the oracle node registered in the oracle contract, validity verification on a signature of the oracle node in the change transaction request and matching verification on an account of the oracle node in the change transaction request.

16. The electronic device according to claim 14, wherein the at least one processor invokes the oracle contract to perform the change transaction request by:
acquiring a change timestamp of the target data subject from the change transaction request and comparing the change timestamp with a latest timestamp of the target data subject recorded on the chain; and
in response to the latest timestamp being earlier than the change timestamp, determining that the data of the target data subject changes.

17. The electronic device according to claim 12, wherein at least one oracle node is configured and at least one target data subject is configured.

18. An electronic device, comprising:
at least one processor; and
a memory communicatively connected to the at least one processor, wherein the memory stores instructions executable by the at least one processor to enable the at least one processor to perform the method according to claims 8.

19. A non-transitory computer-readable storage medium storing computer instructions for causing a computer to perform the method according to claim 1.

20. A non-transitory computer-readable storage medium storing computer instructions for causing a computer to perform the method according to claim 8.
